(19) United States
(12) Patent Application Publication
(10) Pub. No.: US 2007/0096622 A1
(43) Pub. Date: May 3, 2007

(54) IMAGE DISPLAY APPARATUS AND METHOD OF MANUFACTURING THE SAME

(76) Inventors: Akiyoshi YAMADA, Fukaya-shi (JP); Hiromitsu TAKEDA, Kawasaki-shi (JP); Yuichi SHINBA, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/613,207

(22) Filed: Dec. 20, 2006

Related U.S. Application Data
(63) Continuation of application No. PCT/JP05/11451, filed on Jun. 22, 2005.

(30) Foreign Application Priority Data
Jun. 23, 2004 (JP) 2004-185378

(51) Int. Cl. H01J 63/04; H01J 1/62

(52) U.S. Cl. 313/495

(57) ABSTRACT

An image display apparatus includes two substrates arranged to face each other with a gap therebetween, and a sealing portion which seals predetermined positions of the substrates and defines a closed space between the two substrates. The sealing portion includes a low-melting point metal material applied along the predetermined positions, and a composite material layer provided between a surface of the substrate and the low-melting point metal material and including metal powder material and frit glass. The metal powder material has a bonding property to glass, an affinity to the low-melting point metal material, and a solubility of less than 10% at a temperature of 500° C. or less with respect to the low-melting point metal material to be melted.

### CROSS REFERENCE TO RELATED APPLICATIONS

This is a Continuation Application of PCT Application No. PCT/JP2005/011451, filed Jun. 22, 2005, which was published under PCT Article 21(2) in Japanese.

This application is based upon and claims the benefit of priority from prior Japanese Patent Application No. 2004-185378, filed Jun. 23, 2004, the entire contents of which are incorporated herein by reference.

### BACKGROUND OF THE INVENTION

1. Field of the Invention

The present invention relates to a flat-panel image display apparatus having a vacuum-sealed structure in which glass substrates arranged to face each other are sealed to each other, and a method of manufacturing such a flat-panel image display apparatus.

2. Description of the Related Art

Recent years, there have been various flat-panel image display apparatus proposed and receiving attention as an image display apparatus due to its effective usability in a space or designing. Of these, the field emission display (to be referred FED hereinafter) of an electron emission type is expected to be an excellent type of display because of its merits such as high brightness, high resolution, and low power consumption.

Generally, a flat-type image display apparatus comprises two glass substrates each formed of a glass plate, which are arranged to face each other with a predetermined interval therebetween. These glass substrates are adhered together by the peripheral portions thereof, thereby forming an envelope. It is of an important condition that the internal part of the envelope, which is the space portion of the two glass substrate, should be maintained at a high vacuum degree. More specifically, when the vacuum degree is low, the lifetime of the electron emission element is shortened. As a result, the durability of the image display apparatus is deteriorated.

In the case where the inside of such a narrow closed space should be maintained at a high vacuum degree, it is very difficult to use an organic material-based sealing member, which may transmit gas even though it is a very small amount, as the sealing member to seal the glass substrates. Therefore, it is essential to use, as the sealing member, an inorganic adhesive or sealing member.

For example, Jpn. Pat. Appln. KOKAI Publication No. 2002-319346 discloses that a low-melting point metal material such as In or Ga is used as a sealing member for bonding glass substrates together or vacuum-sealing glass substrates. When heated to a melting point and these low-melting point metal materials melt, each exhibits a high wettability to glass, thereby making it possible to carry out a highly air-tight sealing.

Recently, however, widely-used flat-panel image display apparatus have a circumferential length of glass substrate of more than 3 m in some cases, and therefore it is necessary to seal a large area as compared to the cases of the conventional cathode ray tubes, etc. As compared to the cathode ray tube or the like, the introduction factor of the sealing defects may increase nearly by double figures. Thus, the sealing of glass substrate together is a very complicated work.

The flat-panel image display apparatus requires such a restricted vacuum specification for the envelope, and therefore it is in some cases subjected to a heat treatment at a temperature extremely higher than the melting point of the sealing material. Under such a high-temperature heating treatment, the wettablity of the sealing material with respect to glass is lowered, and therefore the sealing can no longer exhibit a full bonding or sealing effect. As a result, there start to arise such a problem that a large-sized display apparatus that maintains a high vacuum degree cannot be measured.

### BRIEF SUMMARY OF THE INVENTION

The present invention has been contrived in consideration of the above circumstances and its object is to provide an image display apparatus which can maintain a high vacuum degree and is improve in the reliability, and a method of manufacturing an image display apparatus.

According to an aspect of the present invention, there is provided an image display apparatus comprising: two substrates arranged to face each other with a gap therebetween, and a sealing portion which seals predetermined positions of the substrates and defines a closed space between the two substrates. The sealing portion includes a low-melting point metal material applied along the predetermined positions; and a composite material layer provided between a surface of the substrate and the low-melting point metal material and including metal powder material and frit glass, the metal powder material having a bonding property to glass, an affinity to the low-melting point metal material, and a solubility of less than 10% at a temperature of 500° C. or less with respect to the low-melting point metal material to be melted.

According to another aspect of the present invention, there is provided a method of manufacturing an image display apparatus comprising: an envelope including a first substrate and a second substrate arranged to face the first substrate; and a plurality of display elements provided in the envelope, the method comprising: bonding one surface of a side wall having a rectangular frame shape to a peripheral portion of an inner surface of at least one of the substrates, with a low-melting point glass material; forming a composite material layer by applying a mixture of a metal powder material and frit glass to at least one of an other surface of the side wall and a predetermined position of an other substrate, which faces the side wall, and baking the side wall and the other substrate; forming a sealing layer made of a low-melting point material on at least of the other surface of the side wall and the predetermined position of the other substrate; and arranging the first substrate and the second substrate to face each other while interposing the side wall therebetween and subjecting them to a heat treatment in a vacuum to melt the sealing layer, thereby sealing the first substrate and the second substrate together with the sealing layer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a brief structure of an FED according to an embodiment of the present invention;

FIG. 2 is a sectional view showing the FED of the embodiment, taken along the line II-II in FIG. 1;

FIG. 3 is a enlarged sectional view showing a metal layer of a sealing portion of the FED; and

FIG. 4 is a sectional view showing a sealing portion of an FED according to another embodiment.

### DETAILED DESCRIPTION OF THE INVENTION

Embodiments in which a flat-panel image display apparatus of the present invention is applied to an FED, will now be described in detail with reference to accompanying drawings.

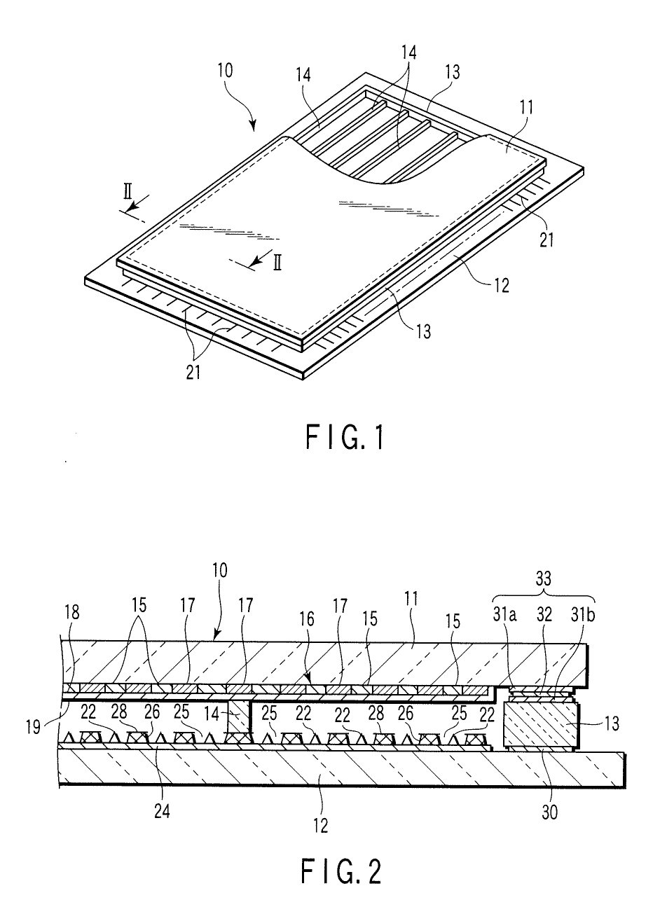

As shown in FIGS. 1 and 2, the FED includes a first substrate 11 and a second substrate 12 each made of a rectangular glass plate. The first and second substrates 11 and 12 are arranged to oppose each other with an interval of about 1.0 to 2.0 mm between these substrates, and the first substrate 11 and second substrate 12 are joined together by their edge portions via a side wall 13 of a rectangular frame shaped-glass, and thus a flat rectangular vacuum envelope 10 the inside of which is maintained in a vacuum is formed.

The side wall 13, which serves as a joint member, is sealed to the peripheral portion of the inner surface of the second substrate 12 with a low-melting point glass 30 such as frit glass. As described later, the side wall 13 is sealed to the peripheral portion of the inner surface of the second substrate 12 with a sealing portion 33 containing a low-melting point metal, which serves as a sealing member. In this manner, the side wall 13 and sealing portion 33 air-tightly bond the first substrate 11 and second substrate 12 together at their peripheral portions, and thus an air-tightly enclosed space is defined between the first and second substrates 11 and 12.

Inside the vacuum envelope 10, a plurality of plate-shaped support members 14, formed of glass, for example, are provided in order to support the atmospheric load applied on the first substrate 11 and second substrate 12. These support members 14 extend in a direction parallel to a shorter side of the vacuum envelope, and are arranged at regular intervals in the direction parallel to the short side. The shape of the support members 14 is not limited to the above-described one, but it is alternatively possible that columnar support members are employed.

A phosphor screen 16 serving as a phosphor surface is formed on an inner surface of the first substrate 11. The phosphor screen 16 includes a plurality of phosphor layers 16 which emit light in red, green and blue, and a plurality of light-shield layers 17 formed alternately between these phosphor layers. Each of the phosphor layers 15 is formed in stripes, dots or rectangular. A metal back 20 made of, for example, an aluminum film, is formed on the phosphor screen 16, and further a getter film 19 is formed to be overlaid on the metal back.

A number of electron emitting elements 18 each emitting electron beams are provided on the inner surface of the second substrate 12, as electron sources for exciting the phosphor layers 15 of the phosphor screen 16. In more detail, a conductive cathode layer 24 is formed on the inner surface of the second substrate 12 and a silicon dioxide film 26 having a plurality of cavities 25 is formed on the conductive cathode layer 24. The gate electrode 28 made of molybdenum, niobium, or the like, is provided on the silicon dioxide film 26.

A conical electron emitting element 22 made of molybdenum or the like is arranged in each cavity on the inner surface of the second substrate 12. These electron emitting elements 22 are arranged in a plurality of columns and a plurality of rows to correspond to the pixels respectively. Further, a number of wiring lines 21 for supplying a potential to the respective electron emitting element 22 are provided in matrix on the inner surface of the second substrate 12, and an end portion of each of the wiring lines is lead out to the outside of the vacuum envelope 10.

In the above-described FED, video signals are input to the electron emitting element 22 and gate electrode 28. With reference to the electron emitting element 22, at a maximum brightness state, a gate voltage of +100V is applied to the gate electrode, and a voltage of +10 kV is applied to the phosphor screen 16. The size of the electron beam emitted from the electron emitting element 22 is modulated by the voltage of the gate electrode 28. Then, the electron beam excites the phosphor layer of the phosphor screen 16 to emit light, thereby displaying an image.

Since such a high voltage is applied to the phosphor screen 16, a high distortion-point glass is used as a plate glass to form the first substrate 11, the second substrate 12, side wall 13 and the support member 14.

There will now be described in detail the sealing portion 33 which is used to seal the first substrate 11 and the side wall to each other.

As shown in FIG. 2, the sealing portion 33 includes a metal layer 31a formed into a rectangular frame shape along an inner peripheral portion of the first substrate 11, which is a predetermined position of the substrate, a metal layer 31b formed into a rectangular frame shape along the side wall 13 on the end surface side of the first substrate 11, and a sealing layer 32 interposed between the metal layers 31a and 31b and formed of a low-melting point metal material.

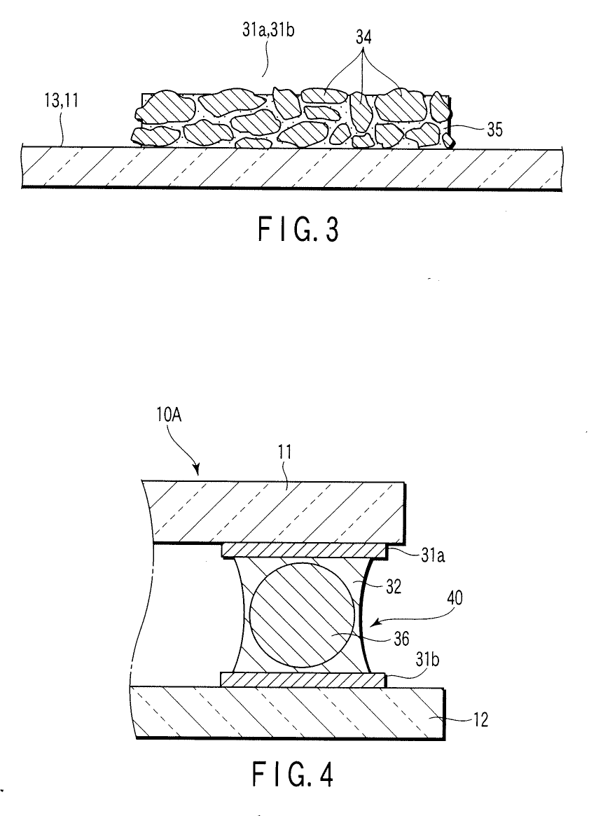

As can be seen in FIG. 3, each of the metal layers 31a and 31b is a composite material layer formed of metal powder 34 and frit glass 35. The metal powder 34 has a bonding property to glass, an affinity to low-melting point metal, and a solubility of less than 10% at a temperature of 500° C. or less with respect to the sealing layer 32 to be melted.

The inventors of the present invention carried out intensive studies and researches on the mechanism of the bonding between glass and metal, and as a part of the researches, they systematically observed the wetting phenomenon of indium (In) which is conventionally used as a sealing member, to glass. As the result, molten In has a wettability to glass, but it also has a strong surface tension. Therefore, it cannot wet and spread over the surface of the glass, but it tends to form a semi-sphere shape. For this reason, it is difficult to seal a long distance with In, and is important to provide a substance to fixate In at a certain place and relatively relax the surface tension.

Based on this conclusion, the inventors conceived the formation of a metal layer on the surface of the glass, and carried out experiments to establish such a formation method. The results of the experiments indicated the following facts, which lead to the following conclusion. As to the above-indicated substance, a metal generally can relatively relax the surface tension of In; however in the case where its form is in a film, many of the usable substances strips off from the surface of the glass when In solidifies. Further, even at a low temperature of less than 500° C., In vanishes from the surface of the glass along with an elapse of time when the metal layer has a solubility to In to a certain degree, and it loses its effect.

From the above-described phenomena, it has been found that the above-described two problems can be solved by forming the metal layer into such a shape that a part thereof is embedded inside the glass, and selecting a material having a low solubility to In. It has been further found that as long as a material satisfies the above-described conditions, a metal other than In, or an alloy which has a low melting point can be employed and it still exhibits a high vacuum sealing ability.

The above-described state in which a portion of a metal is embedded inside the glass can be obtained by the following procedure. That is, powder of a low-melting point glass and powder of metal material are mixed at an appropriate ratio and the mixture of these materials is applied, printed or the like, thereby forming a composite material layer. Then, the composite material layer is heated to a temperature higher than the melting point of the low-melting point glass. Usable examples of the material having a low solubility to the low melting-point metal are metal elements including Fe, Si, Al, Mn, W, Mo, Nb, Ni, Cu, Ti and Ta, alloys containing these elements as main components, and mixtures thereof.

As the metal or alloy having a low melting point, it is advantageous that it contains at least one selected from the group consisting of In, Ga, Sn and Bi, or it may further contain a metal such as Ag, Cu or Al.

FIG. 4 is a cross sectional view showing a part of an FED according to another embodiment of the present invention.

As in the above-described embodiment, a first substrate 11 and a second substrate 12, each made of a rectangular glass plate, are arranged to oppose each other with a predetermined gap therebetween. The first and second substrates are sealed together by their peripheral edge portions via a side wall 36 made of a metal wire having a circular cross section. Thus, a flat rectangular vacuum envelope 10A the inside of which is maintained in a vacuum is formed. The internal structure of the vacuum envelope 10A is the same as that of the vacuum envelope 10, and therefore the explanation thereof will not be repeated.

The side wall 36, which serves as a joint member, is sealed to the peripheral portion of the inner surface of the first substrate 11 and the peripheral portion of the inner surface of the second substrate 12 with a sealing layer 32 containing a low-melting point metal material. In this manner, the side wall 13 and sealing portion 32 air-tightly bond the first substrate 11 and second substrate 12 together at their peripheral portions, and thus an air-tightly enclosed space is defined between the first and second substrates 11 and 12. The first substrate 11 and side wall 36, and the second substrate 12 and side wall 36 are sealed to each other by metal layers 31a and 31b formed on the sealing surfaces of the respective substrates.

A sealing portion 40 used to seal the peripheral portions of the first and second substrates 11 and 12 together will now be described in detail. The sealing portion 40 includes a side wall 36, a metal layer 31a formed into a rectangular frame shape along an inner peripheral portion of the first substrate 11, which is a predetermined position of the substrate, a metal layer 31b formed into a rectangular frame shape along the side wall 13 on the end surface side of the second substrate 12, which is a predetermined position of the substrate, and a sealing layer 32 interposed between the metal layers 31a and 31b and the side wall 36 and formed of a low-melting point metal material.

As in the case of the metal layer shown in FIG. 3, each of the metal layers 31a and 31b is a composite material layer formed of metal powder 34 and frit glass 35. The metal powder 34 has a bonding property to glass, an affinity to low-melting point metal material, and a solubility of less than 10% at a temperature of 500° C. or less with respect to the sealing layer 32 to be melted.

The structure of the FED will now be described in detail with reference to examples.

### EXAMPLE 1

In order to constitute an FED, there were provided first and second substrates 11 and 12 each made of a glass plate having a length of 65 cm and a width of 110 cm. A side wall 13 made of a rectangular frame-shaped glass was bonded with frit glass to an peripheral portion of the inner surface of one substrate, for example, the second substrate 12.

Next, Fe-6% Si powder and frit glass powder were mixed at a ratio of 5:5 by weight to prepare a composite material, and the composite material was further mixed with a binder to impart a viscosity, thereby preparing a paste. The paste was printed by a screen printing device on an upper surface of the side wall 13 and a predetermined position of the inner edge portion of the first substrate 11, that opposes the side wall, to have a width of 10 mm and a thickness of 25 μm, thereby forming the metal layers 31a and 31b. After that the first substrate 11 and the side wall 13 were baked in an atmospheric furnace under predetermined conditions.

Subsequently, using an ultrasonic soldering iron, In was applied on the metal layer 31a and the metal layer 31b, to have a width of 4 mm and a thickness of 0.2 mm, thereby forming a sealing layer 32. The two substrates 11 and 12 were subjected to a heat treatment in a vacuum state of 5×10⁻⁶ Pa while arranging the substrates to face each other with an interval of 100 mm provided between them, and thus In and the metal layers 31a and 31b were melted. After that, the two substrates 11 and 12 were brought into tight contact with each other so that the positions of the metal layers 31a and 31b matched with each other during the process of cooling down, thus making In formed continuously on both surfaces. While maintaining the above-described status, the first and second substrates 11 and 12 were cooled down to solidify the alloy made of the metal layer and In. Thus, the side wall 13 and the first substrate 11 were sealed together.

The vacuum sealing characteristics were evaluated using a pore formed in advice for measurement in the sealing portion 33. According to the results, the leakage amount was 5×10⁻⁹ atm·cc/sec or less, which indicated that the sealing portion exhibited a sufficient sealing effect. From both of these results, and the observation of the appearance, it was clear that crack caused by the sealing of the metal did not occur in the first substrate 11 or the second substrate 12.

### EXAMPLE 2

An FED was manufactured in the following manner. That is, the first and second substrates 11 and 12 each made of a glass plate having a length of 65 cm and a width of 110 cm were prepared. Next, Si powder and frit glass powder were mixed at a ratio of 4:6 by weight to prepare a composite material, and the composite material was further mixed with a binder to impart a viscosity, thereby preparing a paste. The paste was formed into a pattern having a width of 10 mm and a thickness of 25 μm, with use of a metal mask, at a predetermined opposing position of a predetermined substrate, for example, at a predetermined position of the peripheral portion of the inner surface of the second substrate 12. Thus, the metal layers 31a and 31b were formed.

After that, the first substrate 11 and the second substrate 12 were baked in an atmospheric furnace under predetermined conditions. Subsequently, using an ultrasonic soldering iron, 53% Bi—Sn alloy was applied on the metal layer 31a and the metal layer 31b, to have a width of 4 mm and a thickness of 0.2 mm, thereby forming a sealing layer. Then, a side wall 36 made of an Ag-plated Fe-37% Ni alloy metal wire (having a diameter of 1.5 mm) was provided on the sealing layer of one of the substrates.

The two substrates 11 and 12 were subjected to a degas by heating in a vacuum state of 5×10⁻⁶ Pa while arranging the substrates to face each other with an interval of 100 mm provided between them, and thus the metal layers 31a and 31b and the sealing layer were melted. After that, the two substrates 11 and 12 were adhered together at a predetermined position when the temperature reached 200° C. in the cooling process. The molten 53 Bi—Sn alloy has a high affinity towards the side wall 36 made of an Fe-37% Ni alloy wire, and therefore it wetted and spread over the side wall to create a gapless state. While maintaining the above-described status, the sealing layer and metal layer were solidified, thus sealing the two substrates 11 and 12 together. Thus manufactured FED was subjected to a vacuum leakage test as in Example 1, and similar results were obtained.

### EXAMPLE 3

An FED was manufactured in the following manner. That is, the first and second substrates 11 and 12 each made of a glass plate having a length of 65 cm and a width of 110 cm were prepared. Next, Mo powder and frit glass powder were mixed at a ratio of 5:5 by weight to prepare a composite material, and the composite material was further mixed with a binder to impart a viscosity, thereby preparing a paste. The paste was formed into a pattern having a width of 10 mm and a thickness of 25 μm, with use of a metal mask, at a predetermined opposing position of a predetermined substrate, here, at a predetermined position of the peripheral portion of the inner surface of each substrate. Thus, the metal layers were formed.

After that, the first substrate 11 and the second substrate 12 were baked in an atmospheric furnace under predetermined conditions. Subsequently, using an ultrasonic soldering iron, 57% Bi—Sn alloy was applied on each of the metal layers, to form a sealing layer having a width of 4 mm and a thickness of 0.2 mm. Then, an Ag-plated Ti wire (having a diameter of 1.5 mm) was provided as the side wall 36 on the sealing layer of one of the substrates.

The two substrates 11 and 12 were subjected to a degas by heating in a vacuum state of 5×10⁻⁶ Pa while arranging the substrates to face each other with an interval of 100 mm provided between them, and thus the sealing layer was melted. After that, the two substrates 11 and 12 were adhered together at a predetermined position when the temperature reached 200° C. in the cooling process. The molten 57% Bi—Sn alloy has a high affinity towards the side wall 36 made of a Ti wire, and therefore it wetted and spread over the side wall to create a gapless state. While maintaining the above-described status, the sealing layer was solidified, thus sealing the two substrates 11 and 12 together. Thus manufactured FED was subjected to a vacuum leakage test as in Example 1, and similar results were obtained.

It should be noted here that the allowable range of the ratio by weight between the metal power used for the metal layers 31a and 31b and the frit glass, which form the composite material layer, is 95:5 to 5:95. Further, the allowable range for the grain diameter of the metal power used here is 0.5 μm to 50 μm.

As described above, according to the embodiments and examples, it is possible to seal a large-scale glass container that requires a high vacuum degree at a high air-tightness. Thus, a flat panel image display apparatus which can maintain a high vacuum degree and has an improved reliability can be obtained.

It should be noted that the present invention is not limited directly to the above-described embodiments, but the invention in its practical stages can be realized by modifying the structural elements as long as the essence of the invention does not fall out of its scope. Further, the present invention can be modified into various ways by appropriately combining some of the structural elements disclosed in the above-described embodiments. For example, it is possible to delete some of the structural elements from all the structural elements indicated in the embodiments. Further, the structural elements from different embodiments may be combined together appropriately to make another invention.

In the present invention, the measurements, materials, etc. of the spacer or other structural elements are not limited to the values and materials specified in the above-described embodiments, but they can be selected in various ways in accordance with necessity. The present invention can be applied not only to an apparatus which employs an electric field emission type electron emission element as the electron source, but also to a surface conductivity type, or an image display apparatus that uses other type of electron source, such as carbon nano tubes, or some other type of flat-panel image display apparatus in which the interior is maintained at vacuum.

What is claimed is:

1. An image display apparatus comprising: two substrates arranged to face each other with a gap therebetween, and a sealing portion which seals predetermined positions of the substrates and defines a closed space between the two substrates,
the sealing portion including a low-melting point metal material applied along the predetermined positions; and a composite material layer provided between a surface of the substrate and the low-melting point metal material and including metal powder material and frit glass, the metal powder material having a bonding property to glass, an affinity to the low-melting point metal material, and a solubility of less than 10% at a temperature of 500° C. or less with respect to the low-melting point metal material to be melted.

2. The image display apparatus according to claim 1, wherein the metal powder material includes a metal single element containing at least one selected from the group consisting of Fe, Si, Al, Mn, W, Mo, Nb, Ni, Cu, Ti and Ta, an alloy containing these elements as main components, or a mixture thereof.

3. The image display apparatus according to claim 1, wherein the low-melting point metal material includes a metal single element containing at least one selected from the group consisting of In, Ga, Sn and Bi, or an alloy containing these elements as main components.

4. The image display apparatus according to claim 1, which comprises a phosphor layer formed on an inner surface of one of the substrates; and a plurality of electron sources provided on an inner surface of an other one of the substrates, which excite the phosphor layer.

5. A method of manufacturing an image display apparatus comprising an envelope including a first substrate and a second substrate arranged to face the first substrate; and a plurality of display elements provided in the envelope, the method comprising:
bonding one surface of a side wall having a rectangular frame shape to a peripheral portion of an inner surface of at least one of the substrates, with a low-melting point glass material;
forming a composite material layer by applying a mixture of a metal powder material and frit glass to at least one of an other surface of the side wall and a predetermined position of an other substrate, which faces the side wall, and baking the side wall and the other substrate;
forming a sealing layer made of a low-melting point material on at least of the other surface of the side wall and the predetermined position of the other substrate; and
arranging the first substrate and the second substrate to face each other while interposing the side wall therebetween and subjecting them to a heat treatment in a vacuum to melt the sealing layer, thereby sealing the first substrate and the second substrate together with the sealing layer.

6. A method of manufacturing an image display apparatus comprising an envelope including a first substrate and a second substrate arranged to face the first substrate; and a plurality of display elements provided in the envelope, the method comprising:
applying a mixture of a metal powder material and frit glass to a peripheral portion of an inner surface of each of the first substrate and the second substrate;
forming a metal layer by baking the first substrate and the second substrate to melt the mixture;
forming a sealing layer made of a low-melting point material on the metal layer of each of the first substrate and the second substrate;
setting a side wall made of a wire on the sealing layer of one of the substrates; and
sealing the first substrate and the second substrate together with the sealing layer by arranging the first substrate and the second substrate to face each other while interposing the side wall therebetween and subjecting them to a heat treatment in a vacuum to melt the sealing layer.
